(19) United States
(12) Patent Application Publication
(10) Pub. No.: US 2013/0191105 A1
(43) Pub. Date: Jul. 25, 2013

(54) VIRTUAL SYSTEMS TESTING

(71) Applicants: Mohammad Abdirashid, Highland, NY (US); Michael E. Browne, Staatsburg, NY (US); Ali Y. Duale, Poughkeepsie, NY (US)

(72) Inventors: Mohammad Abdirashid, Highland, NY (US); Michael E. Browne, Staatsburg, NY (US); Ali Y. Duale, Poughkeepsie, NY (US)

(73) Assignee: INTERNATIONAL BUSINESS MACHINES COPORATION, Armonk, NY (US)

(21) Appl. No.: 13/354,560

(22) Filed: Jan. 20, 2012

(51) Int. Cl. G06F 9/44

(52) U.S. Cl. 703/21

(57) ABSTRACT

According to exemplary embodiments, a computer program product for testing virtual systems includes a tangible storage medium readable by a processing circuit and storing instructions for execution by the processing circuit for performing a method. The method comprises randomly selecting commands from a pool of commands, generating by a computer a test sequence from the randomly selected commands and simulating performance of the test sequence for a simulated virtual system that is a model of a virtual system. The method also includes recording simulated results of the simulated performance, performing the test sequence on the virtual system, recording actual results of the test sequence being performed on the virtual system, and determining by a computer if the virtual system is operating properly based on a comparison of the simulated results to the actual results.

### BACKGROUND

The present invention relates to virtual systems, and more specifically, to an application or method for testing and verifying performance of virtual systems.

Providers of cloud computing, such as Platform as a Service (PaaS) and Infrastructure as a Service (IaaS), have the competing interests of providing desired performance for consumers or end users while also efficiently using the resources used to provide services to consumers. In some cases, a hardware platform may host a plurality of virtual machines, wherein each virtual machine corresponds to a consumer.

As the adoption of cloud computing grows, the complexity of associated infrastructure and virtual systems that are provided to consumers also increases. The virtual machines and systems are tested to ensure a satisfactory user experience. Performing tests on virtual systems with increased complexity may be an inefficient process. In some cases, manual testing of a virtual system may be a time consuming and costly process.

### SUMMARY

According to exemplary embodiments, a computer program product for testing virtual systems includes a tangible storage medium readable by a processing circuit and storing instructions for execution by the processing circuit for performing a method. The method comprises randomly selecting commands from a pool of commands, generating by a computer a test sequence from the randomly selected commands and simulating performance of the test sequence for a simulated virtual system that is a model of a virtual system. The method also includes recording simulated results of the simulated performance, performing the test sequence on the virtual system, recording actual results of the test sequence being performed on the virtual system, and determining by a computer if the virtual system is operating properly based on a comparison of the simulated results to the actual results.

According to further exemplary embodiments, a computer implemented method for testing virtual systems includes randomly selecting commands from a pool of commands, generating by a computer a test sequence from the randomly selected commands and simulating performance of the test sequence for a simulated virtual system that is a model of a virtual system. The method also includes recording simulated results of the simulated performance, performing the test sequence on the virtual system, recording actual results of the test sequence being performed on the virtual system, and determining by a computer if the virtual system is operating properly based on a comparison of the simulated results to the actual results.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention; and

FIG. 4 illustrates a chart of a process for testing virtual system in accordance with an embodiment of the present invention.

### DETAILED DESCRIPTION

As cloud computing and virtual systems increase in popularity, the complexity of these systems also increases. Exemplary methods and systems provide a test of virtual system performance by creating test sequences of random commands. The test sequence is then performed by a simulated virtual system that is modeled based on a corresponding virtual (also referred to as “virtual machine”). The simulated virtual machine produces results that are saved to a selected location and then compared to results from the test sequence being performed on the corresponding virtual machine. The results from the simulated and actual virtual systems are compared to determine if the actual virtual system is performing properly. The randomly generated string or set of commands that make up the test sequence are used to simulate a series of complex commands or a customer change window (i.e, create an environment where a series of Virtual Infrastructure System tasks happen in certain time span, while other heterogeneous background tasks are also running in the infrastructure). Such commands may include administrative commands used in a data center application. Embodiments of the virtual system may include servers, storage and switches.

Embodiments of the method and system provide an effective and efficient automated test for virtual system performance that verifies that the virtual systems perform as expected to ensure a satisfactory user experience. Embodiments of the method and system use an interface of an infrastructure management structure to perform the test sequence generation, the commands of the sequences and comparisons. One example of a interface of an infrastructure management structure is VMControl, offered by IBM.

The virtual system testing provides improved performance and resource management for end users. In one exemplary embodiment, the virtual system environment operates via a cloud infrastructure in which the access to processing power, memory (e.g., random access memory and data storage) and associated computing devices is managed by a service provider on behalf of the consumer or end user.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

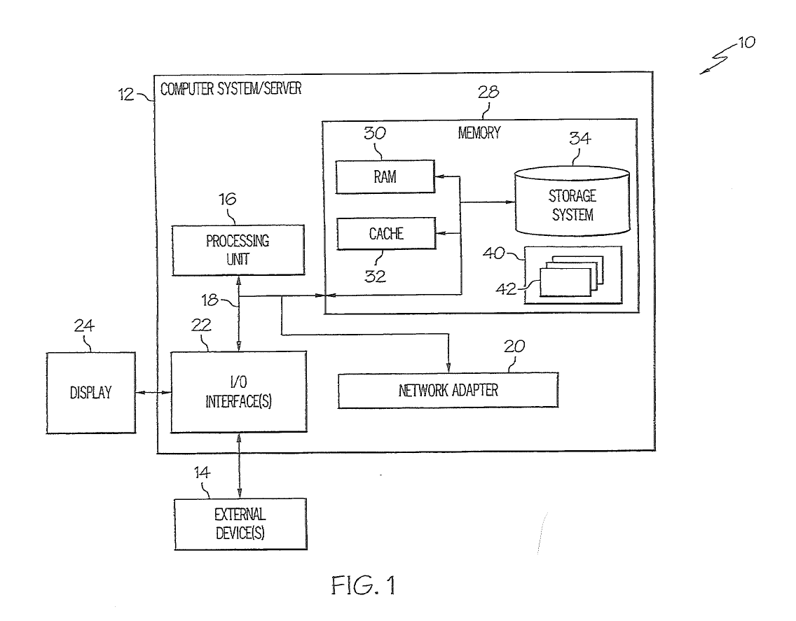

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

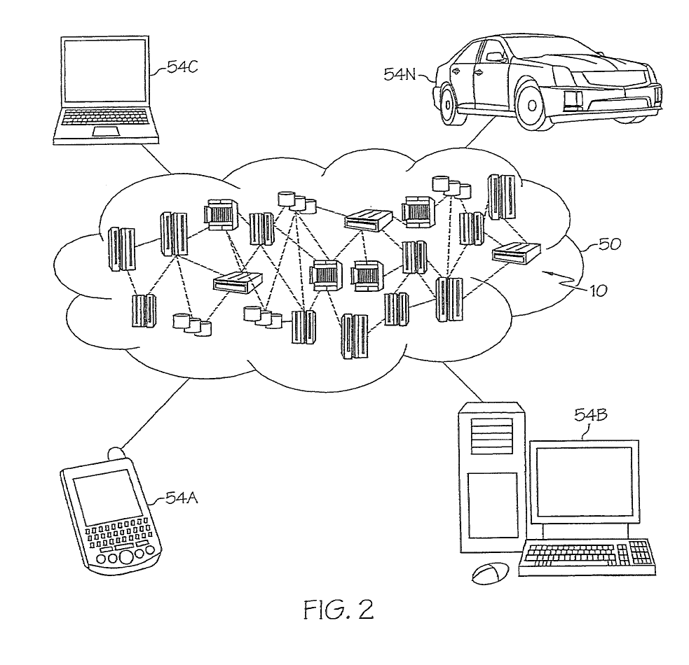

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

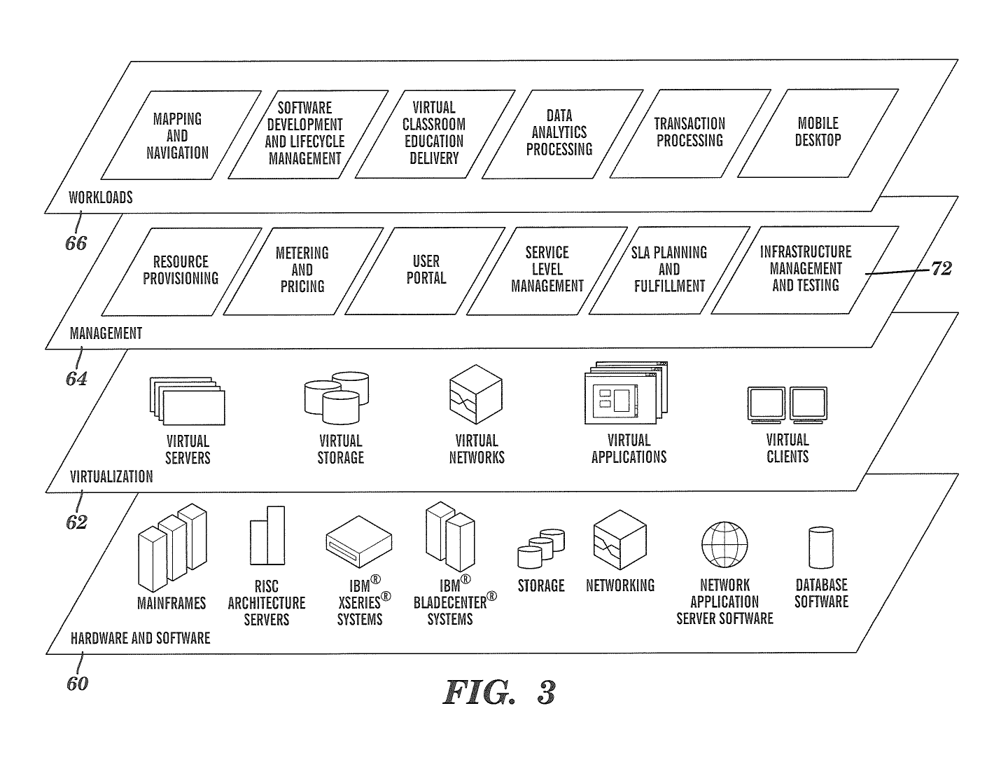

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and data integration workflow processing.

In one exemplary embodiment, an infrastructure management and testing application or module 72 in the management layer 64 implements the testing and monitoring processes described herein; however, it will be understood that the application 72 may be implemented in any layer.

The infrastructure management and testing application 72 includes one or more algorithms or functions to implement embodiments described herein to determine if a selected group of machines, such as servers, switches and storage, are properly operating in the virtual environment. In an embodiment, the infrastructure management and testing application 72 along with other portions of management layer 64 and/or virtualization layer 62 are coupled to and/or reside in the memory 28 shown in FIG. 1. In addition, embodiments of the infrastructure management and testing application 72 include one or more program modules 42 of the program/utility 40 shown in FIG. 1. In a further embodiment, the infrastructure management and testing application 72 is part of the management layer 64 and is executed on hardware located in the hardware and software layer 60. In one embodiment, the infrastructure management and testing application or module 72 is part of a virtual system platform manager, such as VMControl offered by IBM Corp.

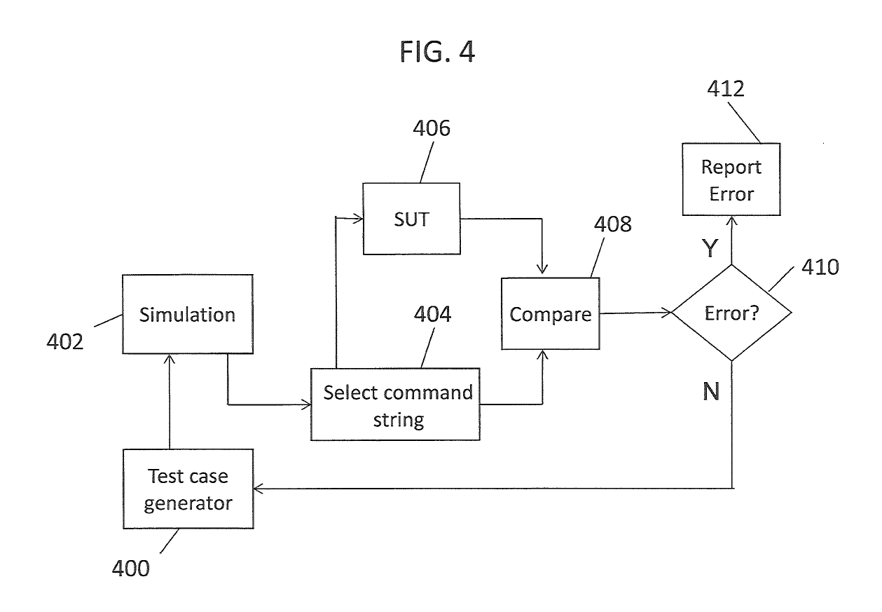

Referring now to FIG. 4, a chart of a process for testing virtual system is shown according to one embodiment. In block 400 a test case generator is used to generate a sequence, set or string of commands to execute on the system under test (SUT). The test case generator may use a random or pseudo-random technique to select valid commands from a pool of available commands. In an embodiment, the test cases include command line interface (CLI) strings that are performed within the virtual system platform manager. Any suitable interface may be used to perform or operate the selected commands, including but not limited to, CLI, graphic user interface and application program interface commands. The commands selected as part of the string are selected from a library of commands that includes commands configured to perform a variety of functions. In an embodiment, a plurality of command strings for testing are randomly generated, where each string comprises a random number of commands to be performed on the SUT. In addition, the plurality of command strings are evaluated to determine which of the strings to use to test the virtual system. In block 402, each of the generated command strings are performed on a simulation or model of the SUT and the results for each command string are recorded or logged to a file. The command strings are then organized and identified by selected characteristics or attributes of the commands or results for the commands, such as information related to the logged results from the simulated tests. Accordingly, in block 404 a command string corresponding to desired attributes is selected for performance on the SUT. In an embodiment, the desired characteristic of the string and/or results are commands or events that are complex operations for the virtual system. In one example, the selected command string includes commands that simulate a complex customer change window. Exemplary commands include but are not limited to: deploying large numbers of images (e.g., a copy of a computer system in the cloud); capturing large numbers of images; viewing images; deleting a large number of images; moving a virtual machine; discovering and integrating new hosts into the infrastructure; updating firmware; monitoring server and storage system pools; creating, listing, removing and editing workloads;.

In block 406, the selected command string is performed on the SUT and the results of the the command string performance are recorded or logged to a file. In block 408, the results of the selected command string for the simulated virtual system and the SUT (actual virtual system) are compared to determine if the SUT is operating properly. In an example, a file containing the recorded results from the simulation of the command string are compared to a file containing the recorded results (i.e., actual results) from the performance of the command string by the SUT. The logged results may include changes to the virtual system environment (e.g., performance parameters), where the environment updates are compared in block 408 to determine if the virtual system is performing properly. Additional parameters that are compared may include time-based performance parameters, such as the time taken to perform the commands. Accordingly, the time taken to perform selected commands may be compared to the simulated results to determine if the virtual system is performing properly. In block 410, an error determination based on the the comparison in the previous block is performed. For example, if a performance error occurs (e.g., the time taken exceeds the simulated time for a command) or an environmental change in the SUT does not match the simulated result, an error is produced. If an error is determined, it is then reported in block 412 to a user (e.g., via an alarm or notification) or is logged to a file. If there is no error, the process returns to block 400 to generate additional command strings.

Embodiments of the method and system provide an effective and efficient automated test for virtual system performance that verifies that the virtual systems perform as expected to ensure a satisfactory user experience. Embodiments evaluate and test performance, functionality and environmental parameters relating to operation of command strings on a virtual system and a simulation of the virtual system. The method and system test dynamic behavior of virtual systems to ensure proper operation during performance of complex commands.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A computer program product for testing virtual systems, the computer program product comprising:
a tangible storage medium readable by a processing circuit and storing instructions for execution by the processing circuit for performing a method comprising:
randomly selecting commands from a pool of commands;
generating a test sequence from the randomly selected commands;
simulating performance of the test sequence for a simulated virtual system that is a model of a virtual system;
recording simulated results of the simulated performance;
performing the test sequence on the virtual system;
recording actual results of the test sequence being performed on the virtual system; and
determining if the virtual system is operating properly based on a comparison of the simulated results to the actual results.

2. The computer program product of claim 1, wherein randomly selecting the commands further comprises generating a plurality of command strings, wherein each command string includes a random set of commands and the randomly selected commands used to generate the test sequence comprise one of the plurality of command strings.

3. The computer program product of claim 2, wherein randomly selecting the commands further comprises simulating performance of the test sequence for the simulated virtual system for the plurality of command strings and selecting the randomly selected commands based in part on simulated results from a simulation of the plurality of command strings.

4. The computer program product of claim 2, wherein randomly selecting the commands further comprises selecting the randomly selected commands based in part on an attribute of the randomly selected commands.

5. The computer program product of claim 2, wherein the plurality of command strings include complex commands for a virtual system.

6. The computer program product of claim 2, wherein the comparison the simulated results to the actual results comprises a comparison of a performance parameter of the simulated results to the performance parameter of the actual results.

7. The computer program product of claim 6, wherein the performance parameter comprises one of time to perform the test sequence and environment changes corresponding to the test sequence.

8. The computer program product of claim 2, wherein performing the test sequence on a virtual system comprises performing the randomly selected commands on an interface of an infrastructure management structure.

9. The computer program product of claim 2, wherein performing the test sequence on a virtual system comprises performing the randomly selected commands on at least one of servers, storage and switches.

10. A computer system for testing virtual systems, the system comprising:
a virtual system, the computer system configured to perform a method comprising:
randomly selecting commands from a pool of commands;
generating a test sequence from the randomly selected commands;
simulating performance of the test sequence for a simulated virtual system that is a model of a virtual system;
recording simulated results of the simulated performance;
performing the test sequence on the virtual system;
recording actual results of the test sequence being performed on the virtual system; and
determining if the virtual system is operating properly based on a comparison of the simulated results to the actual results.

11. The computer system of claim 10, wherein randomly selecting the commands further comprises generating a plurality of command strings, wherein each command string includes a random set of commands and the randomly selected commands used to generate the test sequence comprise one of the plurality of command strings.

12. The computer system of claim 11, wherein randomly selecting the commands further comprises simulating performance of the test sequence for the simulated virtual system for the plurality of command strings and selecting the randomly selected commands based in part on simulated results from a simulation of the plurality of command strings.

13. The computer system of claim 11, wherein randomly selecting the commands further comprises selecting the randomly selected commands based in part on an attribute of the randomly selected commands.

14. The computer system of claim 11, wherein the plurality of command strings include complex commands for a virtual system.

15. The computer system of claim 11, wherein the comparison the simulated results to the actual results comprises a comparison of a performance parameter of the simulated results to the performance parameter of the actual results and wherein the performance parameter comprises one of time to perform the test sequence and environment changes corresponding to the test sequence.

16. A computer implemented method for testing virtual systems, the method comprising:
randomly selecting commands from a pool of commands;
generating by a computer a test sequence from the randomly selected commands;
simulating performance of the test sequence for a simulated virtual system that is a model of a virtual system;
recording simulated results of the simulated performance;
performing the test sequence on the virtual system;
recording actual results of the test sequence being performed on the virtual system; and
determining by a computer if the virtual system is operating properly based on a comparison of the simulated results to the actual results.

17. The computer implemented method of claim 16, wherein randomly selecting the commands further comprises generating a plurality of command strings, wherein each command string includes a random set of commands and the randomly selected commands used to generate the test sequence comprise one of the plurality of command strings.

18. The computer implemented method of claim 17, wherein randomly selecting the commands further comprises simulating performance of the test sequence for the simulated virtual system for the plurality of command strings and selecting the randomly selected commands based in part on simulated results from a simulation of the plurality of command strings.

19. The computer implemented method of claim 17, wherein randomly selecting the commands further comprises selecting the randomly selected commands based in part on an attribute of the randomly selected commands.

20. The computer implemented method of claim 17, wherein the plurality of command strings include complex commands for a virtual system.
